(19) United States
(12) Patent Application Publication
(10) Pub. No.: US 2011/0294011 A1
(43) Pub. Date: Dec. 1, 2011

(54) ENERGY STORAGE DEVICE AND MANUFACTURING METHOD THEREOF

(75) Inventors: Kazutaka KURIKI, Ebina (JP); Mikio YUKAWA, Atsugi (JP)

(73) Assignee: SEMICONDUCTOR ENERGY LABORATORY CO., LTD., Atsugi-shi (JP)

(21) Appl. No.: 13/109,083

(22) Filed: May 17, 2011

(30) Foreign Application Priority Data
Jun. 1, 2010 (JP) 2010-125523

(51) Int. Cl. H01M 4/58; B05D 5/12; H01M 4/04; H01G 9/00; H01G 9/04

(52) U.S. Cl. 429/218.1; 361/500; 427/58

(57) ABSTRACT

An energy storage device is provided in which a discharge capacity can be high and/or in which degradation of an electrode due to repetitive charge and discharge can be reduced. An electrode of the energy storage device which includes a crystalline silicon layer serving as an active material layer is provided. The crystalline silicon layer includes a crystalline silicon region and a whisker-like crystalline silicon region having a plurality of protrusions projected upward from the crystalline silicon region. The protrusions include a first protrusion and a second protrusion; the second protrusion has a larger length along the axis and a sharper tip than the first protrusion.

### TECHNICAL FIELD

The technical field of the present invention relates to an energy storage device and a manufacturing method thereof.

Note that the energy storage device indicates all elements and devices which have a function of storing power.

### BACKGROUND ART

In recent years, energy storage devices such as lithium-ion secondary batteries, lithium-ion capacitors, and air cells have been developed.

An electrode for the energy storage device is manufactured by providing an active material on one surface or opposite surfaces of a current collector. As the active material, a material like carbon or silicon which can absorb and release ions serving as carriers is used. Further, silicon or phosphorus-doped silicon has a higher theoretical capacity than carbon and thus is advantageous in increasing capacity of an energy storage device (e.g., Patent Document 1).

### REFERENCE

[Patent Document 1] Japanese Published Patent Application No. 2001-210315

### DISCLOSURE OF INVENTION

However, even when silicon is used as an active material such as a negative electrode active material, it is difficult to obtain a discharge capacity as high as the theoretical capacity. In view of the above, an object of one embodiment of the present invention is to provide an energy storage device with a large discharge capacity and a manufacturing method thereof.

In addition, in one embodiment of the present invention, it is another object to provide an energy storage device and a manufacturing method thereof in which the performance is improved by, for example, reducing degradation of an electrode due to repetitive charge and discharge.

In addition, in one embodiment of the present invention, it is another object to provide an energy storage device and a manufacturing method thereof in which the performance is improved by, for example, increasing a discharge capacity or charge capacity.

In the disclosed energy storage device, a crystalline silicon layer is used as an active material layer. In addition, the crystalline silicon layer includes a whisker-like crystalline silicon region. Note that “a whisker-like crystalline silicon region” refers to a crystalline silicon region on a surface side of the crystalline silicon layer which has a plurality of column-like protrusions and needle-like protrusions.

With the column-like protrusions, the strength of the active material layer in the thickness direction is increased. An increase in strength of the active material layer can reduce degradation of an electrode due to repetitive charge and discharge or due to vibration or the like. Accordingly, the durability of the energy storage device is improved. In addition, an increase in strength of the active material layer can prevent reduction in discharge capacity or charge capacity. Thus, by using a crystalline silicon layer including a whisker-like crystalline silicon region as an active material layer so that column-like protrusions are included in the crystalline silicon region, the performance of the energy storage device is improved.

In addition, with the needle-like protrusions, the surface area per unit mass of the active material layer is increased. An increase in surface area increases the discharge capacity and the charge capacity of the energy storage device. Thus, by using a crystalline silicon layer including a whisker-like crystalline silicon region as an active material layer so that needle-like protrusions are included in the crystalline silicon region, the performance of the energy storage device is improved.

One embodiment of the present invention is an energy storage device including a crystalline silicon layer serving as an active material layer, in which the crystalline silicon layer has a plurality of protrusions on a surface of the crystalline silicon layer, and the plurality of protrusions include column-like protrusions and needle-like protrusions.

Another embodiment of the present invention is an energy storage device including a current collector and a crystalline silicon layer serving as an active material layer over the current collector; in which the crystalline silicon layer includes a crystalline silicon region and a whisker-like crystalline silicon region having a plurality of protrusions projecting upward from the crystalline silicon region, and in which the plurality of protrusions include column-like protrusions and needle-like protrusions.

Further, a layer including a metal element used in the current collector and silicon used in the active material layer may be provided between the current collector and the active material layer. With the layer, a low-density region (a sparse region) is not formed between the current collector and the active material layer; thus, characteristics such as adhesion of the current collector and the active material layer are improved.

Further, silicide including a metal element used in the current collector and silicon used in the active material layer may be provided between the current collector and the active material layer.

The metal element used in the current collector may be zirconium, titanium, hafnium, vanadium, niobium, tantalum, chromium, molybdenum, tungsten, cobalt, or nickel.

The column-like protrusion may be a cylinder-like protrusion or a rectangular column-like protrusion.

The needle-like protrusion may be a corn-like protrusion or a pyramid-like protrusion.

Another embodiment of the present invention is a method for manufacturing an energy storage device, which includes a step of forming a crystalline silicon layer, as an active material layer, including a crystalline silicon region having column-like protrusions and needle-like protrusions over a current collector by a low-pressure chemical vapor deposition (LPCVD) method using a deposition gas containing silicon.

One embodiment of the present invention can provide an energy storage device with a high discharge capacity and a manufacturing method thereof.

In addition, one embodiment of the present invention can provide a high-performance energy storage device and a manufacturing method thereof in which, for example, an electrode is less likely to break.

### BRIEF DESCRIPTION OF DRAWINGS

FIGS. 1A to 1C are cross-sectional views illustrating a structure and a manufacturing method of an electrode of an energy storage device.

FIG. 2 is a cross-sectional view illustrating a manufacturing method of an electrode of an energy storage device.

FIGS. 3A and 3B are a plan view and a cross-sectional view illustrating one embodiment of an energy storage device.

FIG. 4 is a perspective view illustrating an application example of an energy storage device.

FIG. 5 is a planar SEM image of crystalline silicon.

FIG. 6 is a cross-sectional TEM image of crystalline silicon.

FIG. 7 is an enlarged image of a vicinity of an interface between a current collector and an active material layer.

FIG. 8 shows a two-dimensional elemental mapping of a vicinity of an interface between a current collector and an active material layer using an EDX.

FIG. 9 illustrates an example of a method for manufacturing a secondary battery.

FIG. 10 illustrates a structure of an RF power feeding system.

FIG. 11 illustrates a structure of an RF power feeding system.

FIG. 12 is a cross-sectional TEM image of a protrusion.

FIG. 13 is a cross-sectional TEM image of a protrusion.

FIG. 14 is a perspective view illustrating an application example of an energy storage device.

### BEST MODE FOR CARRYING OUT THE INVENTION

Hereinafter, embodiments of the present invention will be described with reference to the drawings. Note that the present invention is not limited to the following description and it will be readily appreciated by those skilled in the art that modes and details can be modified in various ways without departing from the spirit and the scope of the present invention. Accordingly, the present invention should not be construed as being limited to the description of the embodiments to be given below. Note that in the drawings which are referred to, like reference numerals designate like portions in different drawings in some cases. Further, in some cases, the same hatching patterns are applied to similar parts and the reference numerals thereof may be omitted.

### Embodiment 1

In this embodiment, a structure of an electrode of an energy storage device which is one embodiment of the present invention and a method for manufacturing the electrode will be described.

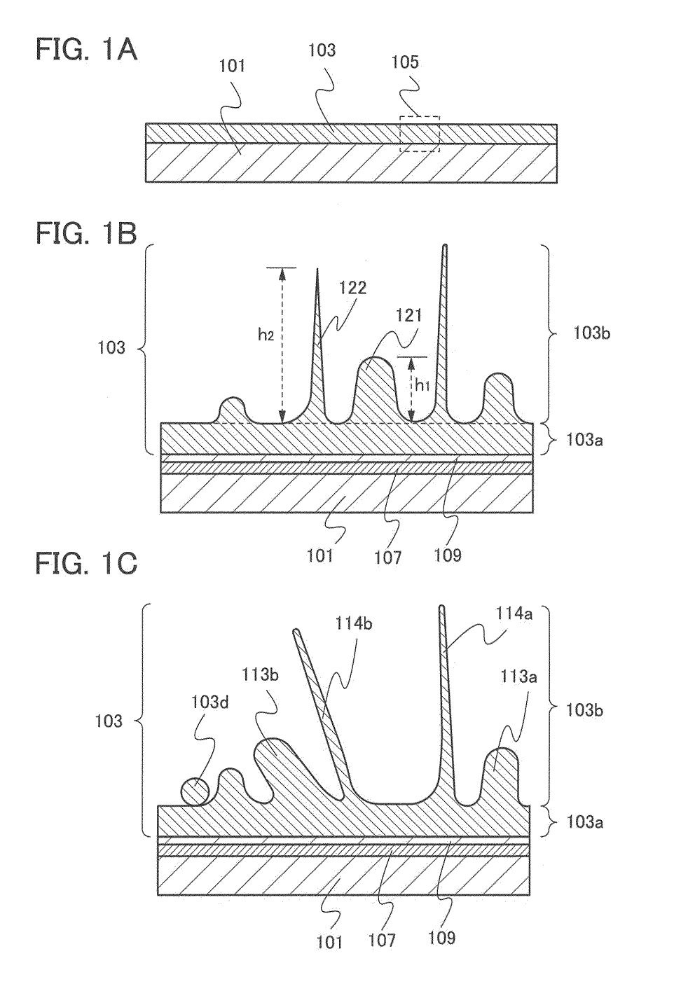

An example of a structure of the electrode of the energy storage device will be described with reference to FIGS. 1A to 1C.

As in FIG. 1A, the electrode of the energy storage device includes a crystalline silicon layer serving as an active material layer 103 over a current collector 101.

FIG. 1B is an enlarged view of the current collector 101 and the active material layer 103 surrounded by a dashed line 105 in FIG. 1A.

The active material layer 103 includes a crystalline silicon region 103a and a whisker-like crystalline silicon region 103b formed on the crystalline silicon region 103a. Note that the interface between the crystalline silicon region 103a and the whisker-like crystalline silicon region 103b is not clear. Thus, a plane that is in the same level as the bottom of the deepest valley of valleys formed among protrusions of the whisker-like crystalline silicon region 103b and is parallel to the surface of the current collector is regarded as the interface between the crystalline silicon region 103a and the whisker-like crystalline silicon region 103b.

The crystalline silicon region 103a covers the current collector 101. The whisker-like crystalline silicon region 103b has a plurality of whisker-like protrusions which are dispersed.

The whisker-like crystalline silicon region 103b has a plurality of protrusions including column-like protrusions and needle-like protrusions. The top of the protrusion may be rounded. The diameter of the protrusion is greater than or equal to 50 nm and less than or equal to 10 μm, preferably greater than or equal to 500 nm and less than or equal to 3 μm. In addition, the length along the axis of the protrusion is greater than or equal to 0.5 μm and less than or equal to 1000 μm, preferably greater than or equal to 1 μm and less than or equal to 100 μm.

The column-like protrusions may include cylinder-like protrusions or rectangular column-like protrusions. In FIG. 1B, a column-like protrusion 121 is projected upward from the crystalline silicon region.

Note that the length h₁ along the axis of the column-like protrusion refers to the distance between the top surface (the upper surface) of the protrusion and the crystalline silicon region 103a along the axis running through the center of the top surface of the protrusion. Further, the thickness of the whisker-like crystalline silicon region 103b in a portion having the column-like protrusion refers to the length of the line which runs from the center of the top surface of the protrusion perpendicularly to the surface of the crystalline silicon region 103a.

The needle-like protrusions may include corn-like protrusions or pyramid-like protrusions. In FIG. 1B, a needle-like protrusion 122 is projected upward from the crystalline silicon region.

Note that the length h₂ along the axis of the needle-like protrusion refers to the distance between the top of the protrusion and the crystalline silicon region 103a along the axis running through the top of the protrusion. Further, the thickness of the whisker-like crystalline silicon region 103b in a portion having the needle-like protrusion refers to the length of the line which runs from the top of the protrusion perpendicularly to the surface of the crystalline silicon region 103a.

Note that the direction in which a protrusion extends from the crystalline silicon region 103a is referred to as a longitudinal direction. A cross-sectional shape along the longitudinal direction is referred to as a longitudinal cross-sectional shape. In addition, the cross-sectional shape along the direction perpendicular to the longitudinal direction is referred to as a transverse cross-sectional shape.

As illustrated in FIG. 1B, the longitudinal direction of the protrusions formed in the whisker-like crystalline silicon region 103b may be the same direction, e.g., the normal direction to the surface of the crystalline silicon region 103a. Note that the longitudinal direction of the protrusions may be substantially the same as the normal direction to the surface of the crystalline silicon region 103a, and it is preferable that the difference between the longitudinal direction of each of the protrusions and the normal direction to the surface of the crystalline silicon region 103a be typically within 5°. In FIG. 1B, only the longitudinal cross-sectional shapes are illustrated in the whisker-like crystalline silicon region 103b.

Alternatively, as in FIG. 1C, the longitudinal directions of the protrusions formed in the whisker-like crystalline silicon region 103b may be varied.

Typically, the whisker-like crystalline silicon region 103b may include a first protrusion whose longitudinal direction is substantially the same as the normal direction to the surface of the crystalline silicon region 103a and a second protrusion whose longitudinal direction is different from the normal direction. In FIG. 1C, a column-like protrusions 113a and a needle-like protrusions 114a are provided as the first protrusions and a column-like protrusions 113b and a needle-like protrusions 114b are provided as the second protrusions.

When the longitudinal directions of the protrusions are varied, as in FIG. 1C, a transverse cross-sectional shape of a protrusion like a region 103d exists in addition to the longitudinal cross-sectional shapes of protrusions in the cross-section of the whisker-like crystalline silicon region 103b. The region 103d is circular because it is a transverse cross-sectional shape of a cylinder-like protrusion or a corn-like protrusion. When the protrusion has a rectangular column shape or a pyramid-like shape, the region 103d is polygonal.

The protrusions in the whisker-like crystalline silicon region 103b include column-like protrusions and needle-like protrusions.

The column-like protrusions can increase the strength of the active material layer in the thickness direction of the whisker-like crystalline silicon region 103b, whereby the electrode can be prevented from breaking. Accordingly, degradation of the electrode due to repetitive charge and discharge can be reduced. In addition, an increase in strength of the active material layer can prevent reduction in discharge capacity or charge capacity. In addition, an increase in strength of the active material layer can reduce degradation of an electrode due to vibration or the like. Thus, the performance of the energy storage device can be improved; for example, the energy storage device can be used for a long time.

Further, the needle-like protrusions allow the protrusions to be entangled with each other so that they can be prevented from being released when the energy storage device is charged or discharged. Accordingly, degradation of the electrode due to repetitive charge and discharge can be reduced and the energy storage device can be used for a long time.

In addition, the needle-like protrusion has a larger surface area per unit mass than the column-like protrusion. With the needle-like protrusions having a large surface area, the rate at which a reaction substance (e.g., lithium ions) in an energy storage device is absorbed to or released from crystalline silicon is increased per unit mass. When the rate at which the reaction substance is absorbed or released is increased, the amount of absorption or release of the reaction substance at a high current density is increased; therefore, the discharge capacity or charge capacity of the energy storage device can be increased. Thus, by using a crystalline silicon layer including a whisker-like crystalline silicon region as an active material layer so that needle-like protrusions are included in the crystalline silicon region, the performance of the energy storage device can be improved.

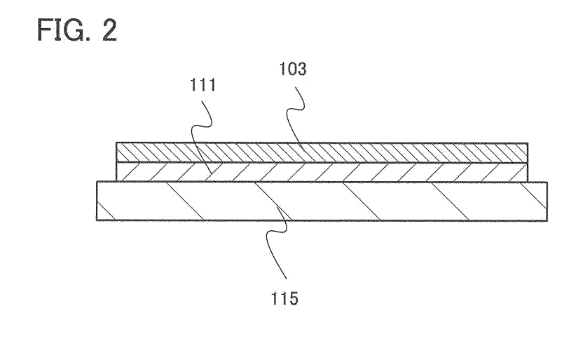

Next, an example of a method for manufacturing the electrode of the energy storage device will be described with reference to FIGS. 1A to 1C and 2.

In FIGS. 1A to 1C, a conductive material having a foil shape, a plate shape, or a net shape is used as the current collector 101. The current collector 101 can be formed using, without a particular limitation, a metal element with high conductivity typified by platinum, aluminum, copper, or titanium. Note that the current collector 101 may be formed using an aluminum alloy to which an element which improves heat resistance, such as silicon, titanium, neodymium, scandium, or molybdenum, is added.

Alternatively, the current collector 101 may be formed using a metal element which forms silicide by reacting with silicon. Examples of the metal element which forms silicide by reacting with silicon include zirconium, titanium, hafnium, vanadium, niobium, tantalum, chromium, molybdenum, tungsten, cobalt, nickel, and the like.

As in FIG. 2, the current collector 111 can be formed over the substrate 115 by a sputtering method, an evaporation method, a printing method, an ink jetting method, a CVD method, or the like as appropriate.

Then, as in FIG. 1A, a crystalline silicon layer is formed on the current collector 101 as the active material layer 103 by a thermal CVD method, preferably by an LPCVD method. Note that while an example where the active material layer 103 is formed on one surface of the current collector 101 is illustrated in FIG. 1A, the active material layer may be formed on opposite surfaces of the current collector.

In the formation of the crystalline silicon layer by an LPCVD method, a deposition gas containing silicon is used as a source gas and heating is performed at a temperature higher than 550° C. and lower than or equal to the temperature which an LPCVD apparatus and the current collector 101 can withstand, preferably higher than or equal to 580° C. and lower than 650° C. Examples of the deposition gas containing silicon are silicon hydride, silicon fluoride, and silicon chloride; typically, SiH₄, Si₂H₆, SiF₄, SiCl₄, Si₂Cl₆, or the like is given. Note that one or more of hydrogen and a rare gas, such as helium, neon, argon, or xenon, may be mixed in the source gas.

By forming the crystalline silicon layer as the active material layer 103 by an LPCVD method, a low-density region is not formed between the current collector 101 and the active material layer 103; thus, electrons easily move at the interface between the current collector 101 and the crystalline silicon layer, and also the adhesion can be increased. This is because active species of the source gas are kept supplied to the crystalline silicon layer that is being deposited in a step of forming the crystalline silicon layer, and silicon diffuses into the current collector 101 from the crystalline silicon layer. Even if a region (a sparse region) lacking in silicon is formed, the active species of the source gas which are kept supplied to the region makes a low-density region difficult to be formed in the crystalline silicon layer. In addition, when the crystalline silicon layer is formed over the current collector 101 by vapor-phase growth, throughput can be improved.

Note that oxygen may be contained as an impurity in the active material layer 103. This is because oxygen is released from a quartz chamber of the LPCVD apparatus in the heating for forming the crystalline silicon layer as the active material layer 103 by an LPCVD method, and the oxygen is diffused into the crystalline silicon layer serving as the active material layer 103.

Note that an impurity element imparting one conductivity type, such as phosphorus or boron, may be added to the crystalline silicon layer. A crystalline silicon layer to which an impurity element imparting one conductivity type, such as phosphorus or boron, is added has higher conductivity, whereby the electrical conductivity of the electrode can be increased. Accordingly, the discharge capacity can be even higher.

As illustrated in FIGS. 1B and 1C, a mixed layer 107 may be formed over the current collector 101. For example, the mixed layer 107 may be formed using silicon and a metal element included in the current collector 101. In the case where the mixed layer 107 is formed using silicon and the metal element included in the current collector 101, the mixed layer 107 can be formed by diffusion of silicon from the crystalline silicon layer into the current collector 101 which is caused by the heating for forming the crystalline silicon layer as the active material layer 103 by an LPCVD method.

When the current collector 101 is formed using a metal element which forms silicide by reacting with silicon, silicide including silicon and the metal element is formed in the mixed layer 107; typically, one or more of zirconium silicide, titanium silicide, hafnium silicide, vanadium silicide, niobium silicide, tantalum silicide, chromium silicide, molybdenum suicide, tungsten silicide, cobalt silicide, and nickel silicide, are formed. Alternatively, an alloy layer of silicon and a metal element which forms silicide is formed.

When the mixed layer 107 is provided between the current collector 101 and the active material layer 103, the resistance at the interface between the current collector 101 and the active material layer 103 can be reduced; thus, the conductivity of the electrode (e.g., a negative electrode) can be increased. Accordingly, the discharge capacity can be even higher. In addition, the adhesion between the current collector 101 and the active material layer 103 can be increased, which leads to less degradation of the energy storage device.

Note that oxygen may be contained as an impurity in the mixed layer 107. This is because oxygen is released from a quartz chamber of the LPCVD apparatus in the heating for forming the crystalline silicon layer as the active material layer 103 by an LPCVD method, and is diffused into the mixed layer 107.

Over the mixed layer 107, a metal oxide layer 109 which is formed using an oxide of the metal element included in the current collector 101 may be formed. This is because oxygen is released from the quartz chamber of the LPCVD apparatus in the heating for forming the crystalline silicon layer as the active material layer 103 by an LPCVD method and the current collector 101 is oxidized. Note that when the metal oxide layer 109 is not formed, in the formation of the crystalline silicon layer by an LPCVD method, the chamber may be filled with a rare gas such as helium, neon, argon, or xenon.

When the current collector 101 is formed using the metal element which forms silicide by reacting with silicon, a metal oxide layer is formed of an oxide of the metal element which forms silicide by reacting with silicon as the metal oxide layer 109.

The metal oxide layer 109 is formed of, typically, zirconium oxide, titanium oxide, hafnium oxide, vanadium oxide, niobium oxide, tantalum oxide, chromium oxide, molybdenum oxide, tungsten oxide, cobalt oxide, nickel oxide, or the like. Note that when the current collector 101 is formed using titanium, zirconium, niobium, tungsten, or the like, the metal oxide layer 109 is formed of an oxide semiconductor such as titanium oxide, zirconium oxide, niobium oxide, or tungsten oxide; thus, the resistance at the interface between the current collector 101 and the active material layer 103 can be reduced and the electrical conductivity of the electrode can be increased. Accordingly, the discharge capacity can be even higher.

By the above steps, a high-performance energy storage device with a high discharge capacity and less degradation of an electrode due to repetitive charge and discharge can be manufactured.

### Embodiment 2

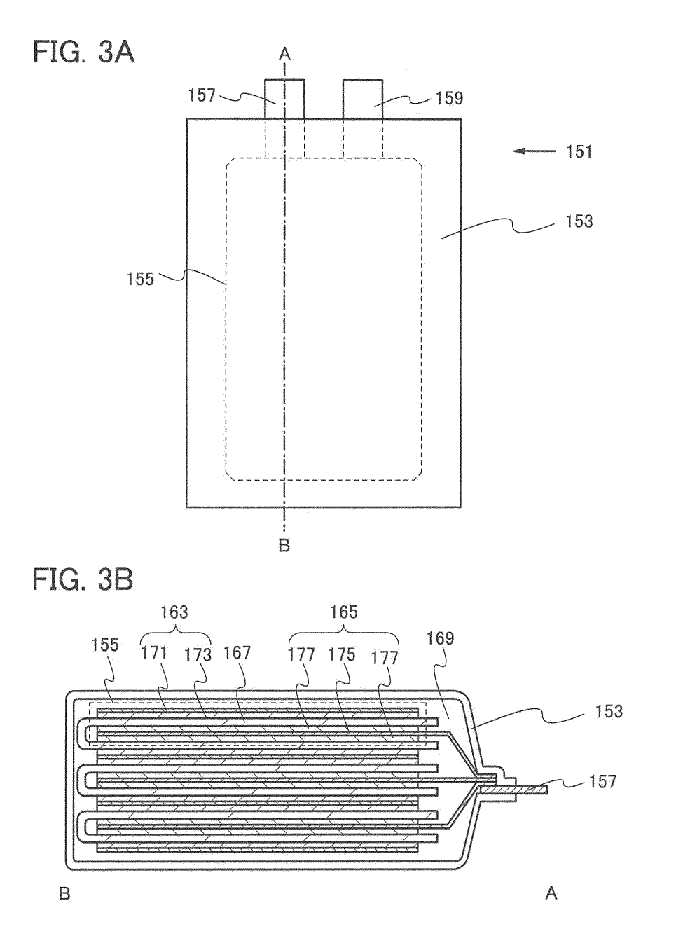

In this embodiment, a structure of an energy storage device will be described with reference to FIGS. 3A and 3B.

First, a structure of a secondary battery is described below as one embodiment of an energy storage device.

Among secondary batteries, a lithium ion battery formed using a lithium-containing metal oxide, such as LiCoO₂, has a high discharge capacity and high safety. Here, the structure of a lithium ion battery, which is a typical example of the secondary battery, is described.

FIG. 3A is a plan view of an energy storage device 151, and FIG. 3B is a cross-sectional view taken along dot-dashed line A-B in FIG. 3A.

The energy storage device 151 illustrated in FIG. 3A includes an energy storage cell 155 in an exterior member 153. The energy storage device further includes terminal portions 157 and 159 which are connected to the energy storage cell 155.

For the exterior member 153, a laminate film, a polymer film, a metal film, a metal case, a plastic case, or the like can be used.

As illustrated in FIG. 3B, the energy storage cell 155 includes a negative electrode 163, a positive electrode 165, a separator 167 between the negative electrode 163 and the positive electrode 165, and an electrolyte 169 with which the exterior member 153 is filled.

The negative electrode 163 includes a negative electrode current collector 171 and a negative electrode active material layer 173. The electrode in Embodiment 1 can be used as the negative electrode 163.

As the negative electrode active material layer 173, the active material layer 103 formed using the crystalline silicon layer which is described in Embodiment 1 can be used. Note that the crystalline silicon layer may be pre-doped with lithium. In addition, in the case where an electrode is formed using opposite surfaces of the negative electrode current collector 171 in an LPCVD apparatus, the negative electrode active material layer 173 which is formed using the crystalline silicon layer is formed while the negative electrode current collector 171 is held by a frame-like susceptor, whereby the negative electrode active material layers 173 can be formed on the opposite surfaces of the negative electrode current collector 171 at the same time and the number of steps can be reduced.

The positive electrode 165 includes a positive electrode current collector 175 and a positive electrode active material layer 177. The negative electrode active material layer 173 is formed on one or opposite surfaces of the negative electrode current collector 171. The positive electrode active material layer 177 is formed on one surface of the positive electrode current collector 175.

The negative electrode current collector 171 is connected to the terminal portion 159. The positive electrode current collector 175 is connected to the terminal portion 157. Further, parts of the terminal portions 157 and 159 are extended out from the exterior member 153.

Note that although a sealed thin energy storage device is described as the energy storage device 151 in this embodiment, an energy storage device can have a variety of shapes, for example, a button shape, a cylindrical shape, or a rectangular shape. Further, although the structure where the positive electrode, the negative electrode, and the separator are stacked is described in this embodiment, a structure where the positive electrode, the negative electrode, and the separator are rolled may be employed.

Aluminum, stainless steel, or the like is used for the positive electrode current collector 175. The positive electrode current collector 175 can have a foil shape, a plate shape, a net shape, or the like as appropriate.

The positive electrode active material layer 177 can be formed using LiFeO₂, LiCoO₂, LiNiO₂, LiMn₂O₄, LiFePO₄, LiCoPO₄, LiNiPO₄, LiMn₂PO₄, V₂O₅, Cr₂O₅, MnO₂, or other lithium compounds as a material. Note that when carrier ions are alkali metal ions other than lithium or alkaline earth metal ions, the positive electrode active material layer 177 can be formed using an alkali metal (e.g., sodium or potassium), beryllium, magnesium, or an alkaline earth metal (e.g., calcium, strontium, or barium), instead of lithium in the above lithium compounds.

As a solute of the electrolyte 169, a material in which lithium ions, which are carrier ions, can be transferred and stably exist is used. Typical examples of the solute of the electrolyte 169 include lithium salt such as LiClO₄, LiAsF₆, LiBF₄, LiPF₆, and Li(C₂F₅SO₂)₂N. Note that when carrier ions are alkali metal ions other than lithium or alkaline earth metal ions, the solute of the electrolyte 169 can be formed using alkali metal salt such as sodium salt or potassium salt, beryllium salt, magnesium salt, calcium salt, alkaline earth metal salt such as strontium salt, or barium salt, or the like, as appropriate.

As a solvent of the electrolyte 169, a material which can transfer lithium ions is used. As the solvent of the electrolyte 169, an aprotic organic solvent is preferably used. Typical examples of aprotic organic solvents include ethylene carbonate, propylene carbonate, dimethyl carbonate, diethyl carbonate, γ-butyrolactonectone, acetonitrile, dimethoxyethane, tetrahydrofuran, and the like, and one or more of them can be used. When a gelled polymer material is used as the solvent of the electrolyte 169, safety against liquid leakage or the like is increased. In addition, the energy storage device 151 can be thin and lightweight. Typical examples of a gelled polymer include a silicon gel, an acrylic gel, an acrylonitrile gel, polyethylene oxide, polypropylene oxide, and a fluorine-based polymer.

As the electrolyte 169, a solid electrolyte such as Li₃PO₄ can be used.

For the separator 167, an insulating porous material is used. Typical examples of the separator 167 include cellulose (paper), polyethylene, and polypropylene.

A lithium ion battery has a small memory effect, a high energy density, and a high discharge capacity. In addition, the driving voltage of a lithium ion battery is high. Thus, the size and weight of the lithium ion battery can be reduced. Further, the lithium ion battery does not easily degrade due to repetitive charge and discharge and can be used for a long time, and therefore enables cost reduction.

Second, a capacitor is described below as one embodiment of an energy storage device. Typical examples of a capacitor include a double-layer capacitor and a lithium ion capacitor.

In the case of a capacitor, instead of the positive electrode active material layer 177 in the secondary battery in FIG. 3A, a material capable of reversibly absorbing lithium ions and/or anions may be used. Typical examples of the material include active carbon, a conductive polymer, and a polyacene organic semiconductor (PAS).

The lithium ion capacitor has high efficiency of charge and discharge, capability of rapid charge and discharge, and a long life to withstand repeated use.

By using the negative electrode described in Embodiment 1 as the negative electrode 163, an energy storage device with a high discharge capacity and less degradation of an electrode due to repetitive charge and discharge can be manufactured.

Further, when the current collector and the active material layer described in Embodiment 1 are used in a negative electrode of an air cell which is another embodiment of an energy storage device, an energy storage device with a high discharge capacity and less degradation of an electrode due to repetitive charge and discharge can be manufactured.

### Embodiment 3

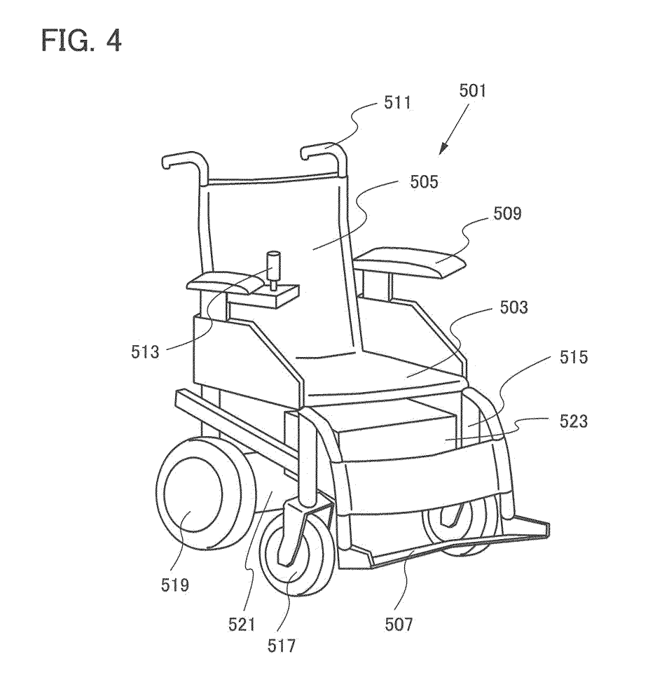

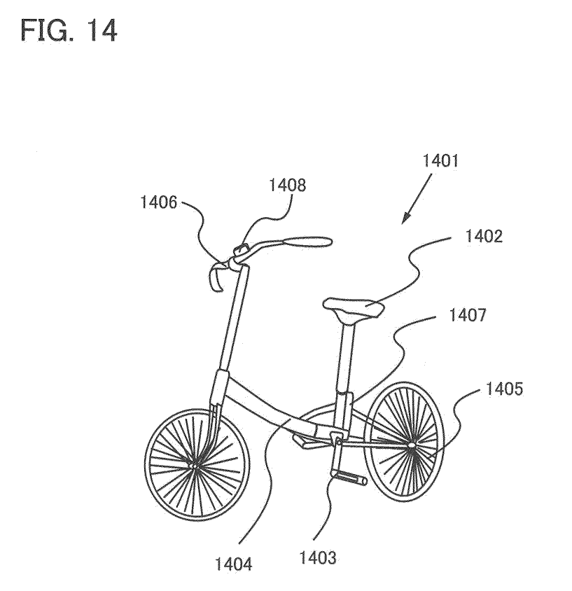

In this embodiment, application examples of an energy storage device described in Embodiment 2 is described with reference to FIGS. 4 and 14.

The energy storage device described in Embodiment 2 can be used in electronic devices, e.g., cameras such as digital cameras or video cameras, digital photo frames, mobile phones (also referred to as cellular phones or cellular phone devices), portable game machines, portable information terminals, or audio players. Further, the energy storage device can be used in electric propulsion vehicles such as electric vehicles, hybrid vehicles, train vehicles, maintenance vehicles, carts, electric bicycles, or wheelchairs. Here, as a typical example of the electric propulsion vehicles, an electric bicycle and a wheelchair are described.

FIG. 14 is a perspective view of an electric bicycle 1401 (or a power-assisted bicycle). The electric bicycle 1401 includes a saddle 1402 on which the rider sits, pedals 1403, a frame 1404, wheels 1405, handlebars 1406 for steering wheels 1405, a driver portion 1407 attached to the frame 1404, and a display device 1408 provided near the handlebars 1406.

The driver portion 1407 includes a motor, a battery, a controller, and the like. The controller detects conditions of the battery (e.g., current, voltage, or a temperature of the battery). The controller adjusts the discharge amount of the battery to control the motor when the electric bicycle 1401 moves, while the controller controls the charge amount when the battery is charged. Further, the driver portion 1407 may be provided with a sensor which senses the pressure that the rider puts on the pedals 1403, the driving speed, and the like and the motor may be controlled according to information from the sensor. Note that while FIG. 14 illustrates a structure where the driver portion 1407 is mounted on the frame 1404, the mounting position of the driver portion 1407 is not limited thereto.

The display device 1408 includes a display portion, a switching button, and the like. The display portion displays the remaining capacity in the battery, the driving speed, and the like. In addition, with the switching button, the motor can be controlled or the display content on the display portion can be changed. Note that while FIG. 14 illustrates a structure where the display device 1408 is mounted near the handlebars 1406, the mounting position of the display device 1408 is not limited thereto.

The energy storage device described in Embodiment 2 can be used for the battery of the driver portion 1407. The battery of the driver portion 1407 can be externally charged by electric power supply using a plug-in system or contactless power feeding. Further, the energy storage device described in Embodiment 2 can be used for the display device 1408.

FIG. 4 is a perspective view of an electric wheelchair 501. The electric wheelchair 501 includes a seat 503 where a user sits down, a backrest 505 provided behind the seat 503, a footrest 507 provided at the front of and below the seat 503, armrests 509 provided on the left and right of the seat 503, and a handle 511 provided above and behind the backrest 505.

A controller 513 for controlling operation of the wheelchair 501 is provided for one of the armrests 509. The wheelchair 501 is provided with a pair of front wheels 517 at the front of and below the seat 503 and a pair of rear wheels 519 behind and below the seat 503 with the use of a frame 515. The rear wheels 519 are connected to a driver portion 521 having a motor, a brake, a gear, and the like. A control portion 523 including a battery, a power controller, a control means, and the like is provided under the seat 503. The control portion 523 is connected to the controller 513 and the driver portion 521. When the user operates the controller 513, the driver portion 521 is driven through the control portion 523 and thus the operation of moving forward, moving back, turning around, and the like, and the speed of the electric wheelchair 501 are controlled.

The energy storage device described in Embodiment 2 can be used in the battery of the control portion 523. The battery of the control portion 523 can be externally charged by electric power supply using a plug-in system or contactless power feeding. Note that in the case where the electric propulsion vehicle is a train vehicle, the battery can be charged by electric power supply from an overhead cable or a conductor rail.

### Embodiment 4

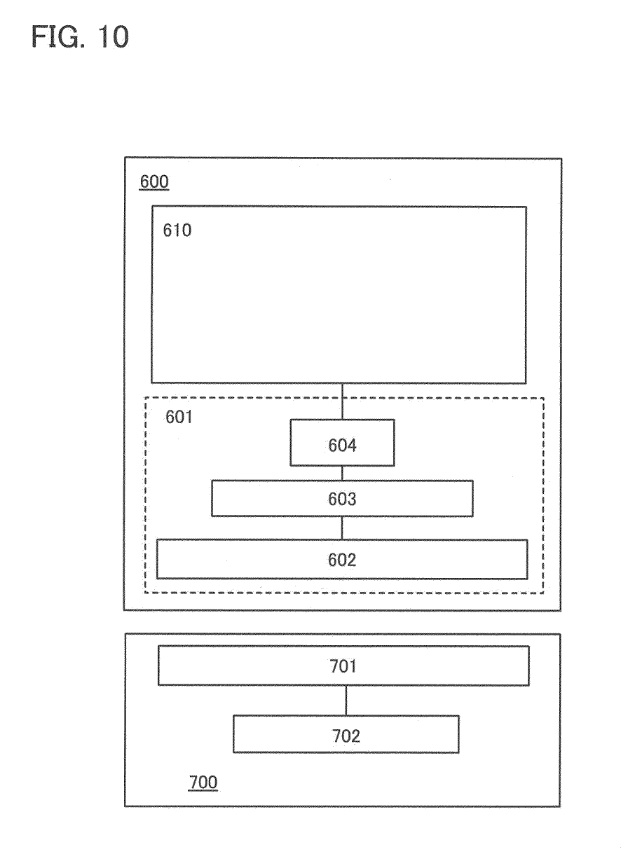

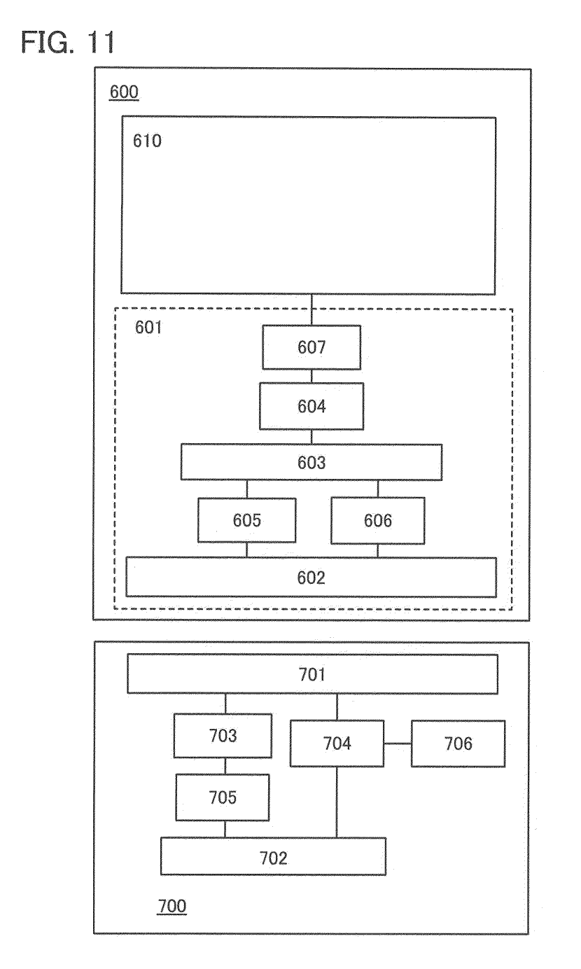

In this embodiment, an example in which a secondary battery which is an example of the energy storage device according to one embodiment of the present invention is used in a wireless power feeding system (also referred to as an RF power feeding system) will be described with reference to block diagrams in FIGS. 10 and 11. In the block diagrams, elements in a power receiving device and a power feeding device are classified according to their functions and included in different blocks. However, it may be practically difficult to completely classify the elements according to their functions; one element may involve a plurality of functions.

First, an example of the RF power feeding system is described with reference to FIG. 10.

A power receiving device 600 is used in an electronic device or an electric propulsion vehicle which is driven by electric power supplied from a power feeding device 700. The power receiving device 600 can be used as appropriate in another device which is driven by electric power. Typical examples of the electronic device include cameras such as digital cameras or video cameras, digital photo frames, mobile phones (also referred to as cellular phones or cellular phone devices), portable game machines, portable information terminals, audio players, display devices, computers, and the like. Typical examples of the electric propulsion vehicles include electric vehicles, hybrid vehicles, electric train vehicles, maintenance vehicles, carts, electric bicycles, wheelchairs, and the like. The power feeding device 700 has a function of supplying electric power to the power receiving device 600.

In FIG. 10, the power receiving device 600 includes a power receiving device portion 601 and a power load portion 610. The power receiving device portion 601 includes at least a power receiving device antenna circuit 602, a signal processing circuit 603, and a secondary battery 604. The power feeding device 700 includes at least a power feeding device antenna circuit 701 and a signal processing circuit 702.

The power receiving device antenna circuit 602 has a function of receiving a signal transmitted by the power feeding device antenna circuit 701 or transmitting a signal to the power feeding device antenna circuit 701. The signal processing circuit 603 has a function of processing a signal received by the power receiving device antenna circuit 602 and controlling charge of the secondary battery 604 and supply of electric power from the secondary battery 604 to the power load portion 610. In addition, the signal processing circuit 603 has a function of controlling operation of the power receiving device antenna circuit 602. Thus, the intensity, frequency, or the like of a signal transmitted from the power receiving device antenna circuit 602 can be controlled.

The power load portion 610 is a driver portion which receives electric power from the secondary battery 604 and drives the power receiving device 600. Typical examples of the power load portion 610 include a motor, a driver circuit, and the like. Another device which receives electric power and drives the power receiving device 600 can be used as the power load portion 610 as appropriate.

The power feeding device antenna circuit 701 has a function of transmitting a signal to the power receiving device antenna circuit 602 or receiving a signal from the power receiving device antenna circuit 602. The signal processing circuit 702 has a function of processing a signal received by the power feeding device antenna circuit 701. In addition, the signal processing circuit 702 has a function of controlling operation of power feeding device antenna circuit 701. Thus, the intensity, the frequency, or the like of a signal transmitted by the power feeding device antenna circuit 701 can be controlled.

The secondary battery according to one embodiment of the present invention is used as the secondary battery 604 included in the power receiving device 600 in the RF power feeding system illustrated in FIG. 10.

With the use of the secondary battery according to one embodiment of the present invention in the RF power feeding system, the amount of energy storage can be larger than that in a conventional secondary battery. Therefore, the time interval of the wireless power feeding can be longer, whereby power feeding can be less frequent.

In addition, with the use of the secondary battery according to one embodiment of the present invention in the RF power feeding system, the power receiving device 600 can be formed to be compact and lightweight when the secondary battery has the same amount of energy storage for driving the power load portion 610 as a conventional one. Therefore, the total cost can be reduced.

Second, another example of the RF power feeding system is described with reference to FIG. 11.

In FIG. 11, a power receiving device 600 includes a power receiving device portion 601 and a power load portion 610. The power receiving device portion 601 includes at least a power receiving device antenna circuit 602, a signal processing circuit 603, a secondary battery 604, a rectifier circuit 605, a modulation circuit 606, and a power supply circuit 607. A power feeding device 700 includes at least a power feeding device antenna circuit 701, a signal processing circuit 702, a rectifier circuit 703, a modulation circuit 704, a demodulation circuit 705, and an oscillator circuit 706.

The power receiving device antenna circuit 602 has a function of receiving a signal transmitted by the power feeding device antenna circuit 701 or transmitting a signal to the power feeding device antenna circuit 701. When the power receiving device antenna circuit 602 receives a signal transmitted by the power feeding device antenna circuit 701, the rectifier circuit 605 has a function of generating a DC voltage from the signal received by the power receiving device antenna circuit 602. The signal processing circuit 603 has a function of processing a signal received by the power receiving device antenna circuit 602 and controlling charge of the secondary battery 604 and supply of electric power from the secondary battery 604 to the power supply circuit 607. The power supply circuit 607 has a function of converting voltage stored by the secondary battery 604 into voltage needed for the power load portion 610. The modulation circuit 606 is used when the power receiving device 600 transmits a signal (or sends a response) to the power feeding device 700.

With the power supply circuit 607, electric power supplied to the power load portion 610 can be controlled. Thus, overvoltage application to the power load portion 610 can be suppressed, and degradation or breakdown of the power receiving device 600 can be prevented.

In addition, with the modulation circuit 606, a signal can be transmitted from the power receiving device 600 to the power feeding device 700. Therefore, when the amount of charged power in the power receiving device 600 is judged to exceed a certain amount, a signal is transmitted from the power receiving device 600 to the power feeding device 700 so that power feeding from the power feeding device 700 to the power receiving device 600 can be stopped. As a result, the secondary battery 604 is not fully charged, which increases the number of times the secondary battery 604 can be charged.

The power feeding device antenna circuit 701 has a function of transmitting a signal to the power receiving device antenna circuit 602 or receiving a signal from the power receiving device antenna circuit 602. When a signal is transmitted to the power receiving device antenna circuit 602, the signal processing circuit 702 has a function of generating a signal which is transmitted to the power receiving device 600. The oscillator circuit 706 has a function of generating a signal with a constant frequency. The modulation circuit 704 has a function of applying voltage to the power feeding device antenna circuit 701 according to the signal generated by the signal processing circuit 702 and the signal with a constant frequency generated by the oscillator circuit 706. Thus, a signal is output from the power feeding device antenna circuit 701. On the other hand, when a signal is received from the power receiving device antenna circuit 602, the rectifier circuit 703 has a function of rectifying the received signal. The demodulation circuit 705 has a function of extracting a signal which is transmitted from the power receiving device 600 to the power feeding device 700, from the signal rectified by the rectifier circuit 703. The signal processing circuit 702 has a function of analyzing the signal extracted by the demodulation circuit 705.

Note that another circuit may be provided between circuits as long as the RF power feeding can be performed. For example, after the power receiving device 600 receives a signal and the rectifier circuit 605 generates a DC voltage, a circuit such as a DC-DC converter or regulator in a subsequent stage may generate constant voltage. Thus, overvoltage application to an inner portion of the power receiving device 600 can be suppressed.

The secondary battery according to one embodiment of the present invention is used as the secondary battery 604 included in the power receiving device 600 in the RF power feeding system illustrated in FIG. 11.

With the use of the secondary battery according to one embodiment of the present invention in the RF power feeding system, the amount of energy storage can be larger than that in a conventional secondary battery. Therefore, the time interval of the wireless power feeding can be longer, whereby power feeding can be less frequent.

In addition, with the use of the secondary battery according to one embodiment of the present invention in the RF power feeding system, the power receiving device 600 can be formed to be compact and lightweight when the secondary battery has the same amount of energy storage for driving the power load portion 610 as a conventional one. Therefore, the total cost can be reduced.

Note that when the secondary battery according to one embodiment of the present invention is used in the RF power feeding system and the power receiving device antenna circuit 602 and the secondary battery 604 are overlapped with each other, it is preferable that the impedance of the power receiving device antenna circuit 602 is not changed by deformation of the secondary battery 604 due to charge and discharge of the secondary battery 604 and accompanying deformation of the antenna. This is because change of the impedance of the antenna may lead to insufficient electric power supply. In order to prevent this, for example, the secondary battery 604 may be placed in a battery pack formed using metal or ceramics. Note that in that case, the power receiving device antenna circuit 602 and the battery pack are preferably separated from each other by several tens of micrometers or more.

In this embodiment, the signal for charging has no limitation on its frequency and may have any band of frequency as long as electric power can be transmitted. For example, the signal for charging may have any of an LF band at 135 kHz (long wave), an HF band at 13.56 MHz, a UHF band at 900 MHz to 1 GHz, and a microwave band at 2.45 GHz.

A signal transmission method may be properly selected from various methods including an electromagnetic coupling method, an electromagnetic induction method, a resonance method, and a microwave method. In order to prevent energy loss due to foreign substances containing moisture, such as rain and mud, an electromagnetic induction method or a resonance method using a low frequency band, specifically, frequencies of a short wave of 3 MHz to 30 MHz, a medium wave of 300 kHz to 3 MHz, a long wave of 30 kHz to 300 kHz, or a very-low frequency of 3 kHz to 30 kHz, is preferably used.

This embodiment can be implemented in combination with any of the above embodiments.

### Example 1

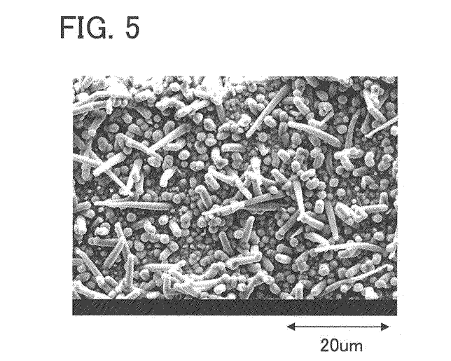

In this example, a secondary battery which is one embodiment of the present invention will be described with reference to FIGS. 5 to 9, 12, and 13. In this example, the secondary battery which is one embodiment of the present invention and a secondary battery for comparison (hereinafter referred to as a comparative secondary battery) were formed and their characteristics were compared.

### (Process for Forming Electrode of Secondary Battery)

A process for forming an electrode of the secondary battery is described.

An active material layer was formed over a current collector, whereby the electrode of the secondary battery was formed.

As a material of the current collector, titanium was used. As the current collector, a sheet of a titanium film (also referred to as a titanium sheet) with a thickness of 100 μm was used.

For the active material layer, crystalline silicon was used.

Over the current collector of the titanium film, crystalline silicon was deposited by an LPCVD method. The deposition of crystalline silicon by an LPCVD method was performed as follows: silane was introduced as a source gas with a flow rate of 300 sccm into a reaction chamber, the pressure of the reaction chamber was 20 Pa, and the temperature of the reaction chamber was 600° C. The reaction chamber used was made of quartz. When the temperature of the current collector was increased, a small amount of helium (He) was introduced.

A crystalline silicon layer obtained in the above process was used as the active material layer of the secondary battery.

### (Structure of Electrode of Secondary Battery)

FIG. 5 shows a planar scanning electron microscope (SEM) image of the crystalline silicon obtained in the above process. As shown in FIG. 5, the crystalline silicon obtained in the above process included a whisker-like crystalline silicon region having a number of protrusions including column-like protrusions and needle-like protrusions. Thus, the surface area of the active material layer can be increased. A long protrusion has a length of approximately 15 μm to 20 μm along its axis. In addition to the protrusions having such a large length along the axis, a plurality of short protrusions having a small length along the axis existed among the protrusions having a large length along the axis. Some protrusions have an axis substantially perpendicular to the titanium film, and some protrusions have a slanting axis.

The directions of the axes of the protrusions were varied. The diameter of a root of a protrusion (a portion of a protrusion at a vicinity of the interface between the crystalline silicon region and the protrusion) was 1 μm to 2 μm.

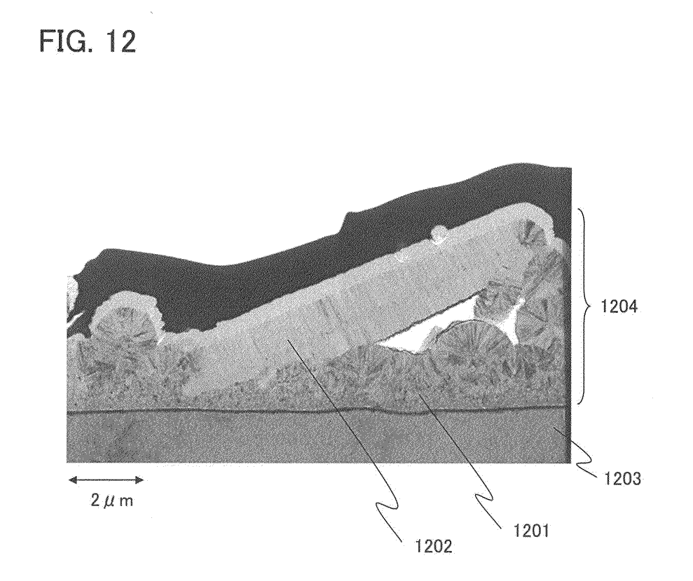

FIG. 12 is a cross-sectional transmission electron microscope (TEM) image of one of the protrusions in the crystalline silicon. As shown in FIG. 12, a crystalline silicon layer 1204, which was an active material layer, was formed over a titanium film 1203, which was a current collector. In the crystalline silicon layer 1204, a crystalline silicon region 1201 and a column-like protrusion 1202 over the crystalline silicon region 1201 were observed. The diameter of the column-like protrusion 1202 was approximately 2 μm. In addition, it was confirmed that the crystal grew substantially in the <211> direction in the column-like protrusions 1202.

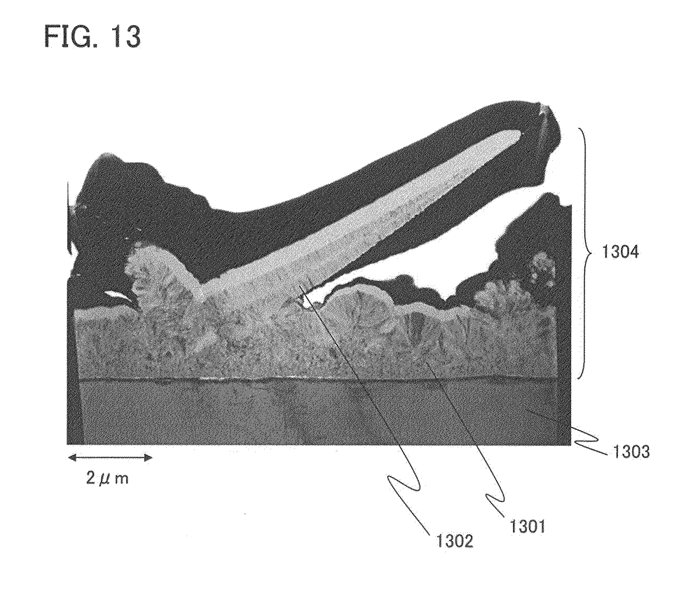

FIG. 13 is a cross-sectional TEM image of another protrusion in the crystalline silicon. As shown in FIG. 13, a crystalline silicon layer 1304, which was an active material layer, was formed over a titanium film 1303, which was a current collector. In the crystalline silicon layer 1304, a crystalline silicon region 1301 and a needle-like protrusion 1302 over the crystalline silicon region 1301 were observed. The diameter of the root of the needle-like protrusion 1302 (a portion of a protrusion at a vicinity of the interface between the crystalline silicon region 1301 and the protrusion 1302) was approximately 1 μm. In addition, it was confirmed that the crystal grew substantially in the <110> direction in the needle-like protrusions 1302.

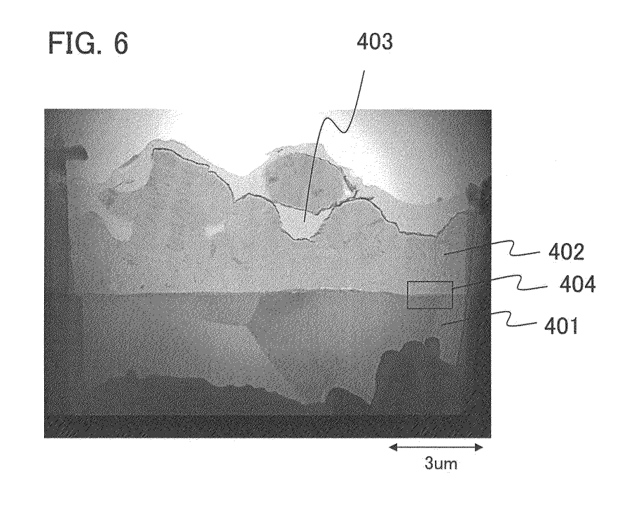

FIG. 6 shows a cross-sectional TEM image of the crystalline silicon obtained in the above process. As shown in FIG. 6, a crystalline silicon layer 402, which was an active material layer, was formed over a titanium film 401, which was a current collector. From FIG. 6, it was confirmed that a low-density region was not formed in an interface vicinity 404 between the titanium film 401 and the crystalline silicon layer 402. The crystalline silicon layer 402 was formed of a crystalline silicon region and a plurality of protrusions which projected from the crystalline silicon region. In addition, there was a space 403 (i.e., a region without protrusions) between the protrusions.

The crystalline silicon layer included the protrusions over the crystalline silicon region. The thickness of the crystalline silicon layer including the protrusions was approximately 3.0 μm, and the thickness of the crystalline silicon region in a valley between the protrusions was approximately 1.5 μm to 2.0 μm. Although not shown in FIG. 6, the length along the axis of the long protrusion was approximately 15 μm to 20 μm, as in FIG. 5.

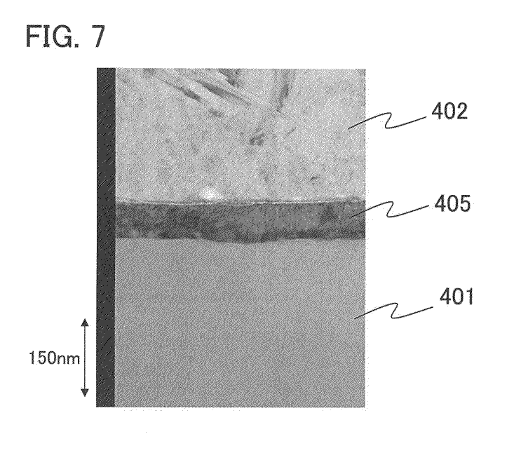

FIG. 7 is an enlarged cross-sectional TEM image of a part of FIG. 6. FIG. 7 is an enlarged image of the interface vicinity 404 between the titanium film 401 and the crystalline silicon layer 402 in FIG. 6. In FIG. 7, it was confirmed that a layer 405 was formed in the vicinity of the interface between the titanium film 401 and the crystalline silicon layer 402.

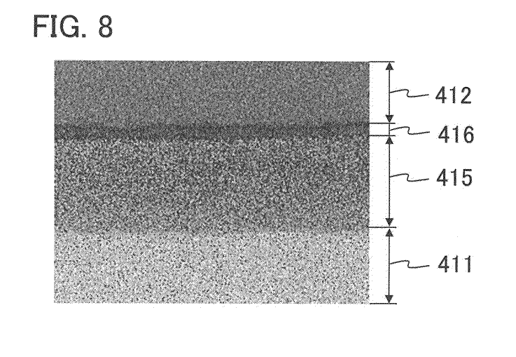

FIG. 8 shows the result of two-dimensional elemental mapping using an energy dispersive X-ray spectrometry (EDX) of a cross section of the vicinity of the interface between the titanium film 401 and the crystalline silicon layer 402. A region 411 contains titanium as a main component. A region 412 contains silicon as a main component. A region 416 contains oxygen and titanium as components. A region 415 contains titanium and silicon as components. The region 415 also contains oxygen as an impurity. In FIG. 8, it was confirmed that the region 411 containing titanium as a main component, the region 415 containing titanium and silicon as components, the region 416 containing oxygen and titanium as components, and the region 412 containing silicon as a main component were stacked in this order. The region 411 corresponds to the titanium film 401, and the region 412 corresponds to the crystalline silicon layer 402. The region 415 corresponds to a mixed layer containing titanium and silicon. The region 416 corresponds to a metal oxide layer.

From the result of two-dimensional elemental mapping using an EDX shown in FIG. 8, it was confirmed that the layer 405 shown in FIG. 7 included the mixed layer containing titanium and silicon and the metal oxide layer over the mixed layer. In the measured area shown in FIG. 8, the metal oxide layer was formed to cover the entire surface of the mixed layer. The thickness of the mixed layer containing titanium and silicon which was included in the layer 405, was approximately 65 nm to 75 nm.

### (Process for Forming Secondary Battery)

A process for forming the secondary battery of this example is described.

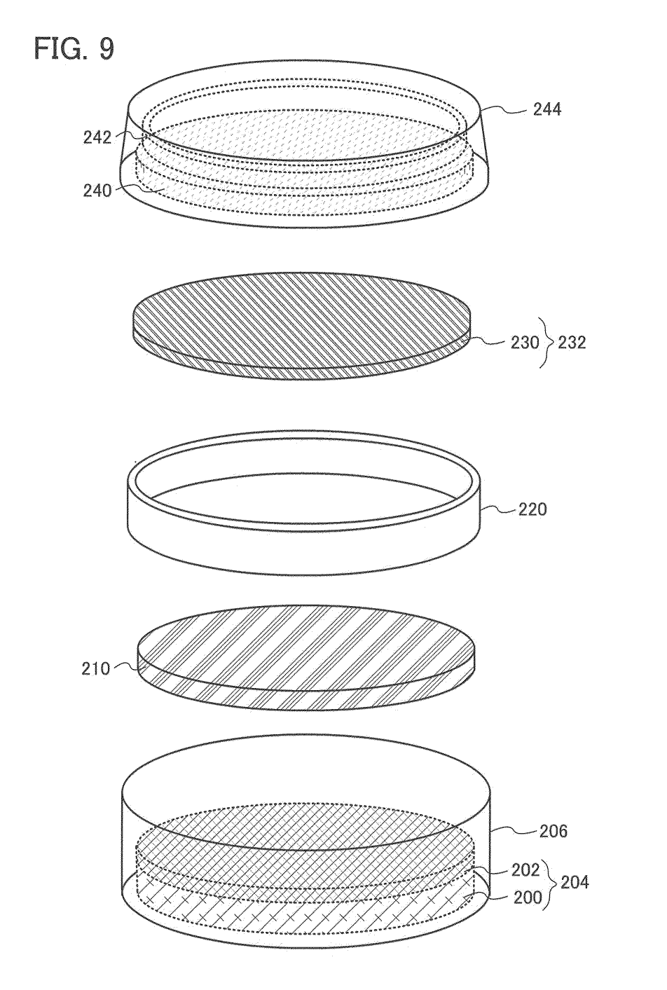

The electrode was formed by forming the active material layer over the current collector as described above. The secondary battery was formed using the electrode obtained. Here, a coin-type secondary battery was formed. A method for forming the coin-type secondary battery is described below with reference to FIG. 9.

As illustrated in FIG. 9, the coin-type secondary battery includes an electrode 204, a reference electrode 232, a separator 210, an electrolyte (not illustrated), a housing 206, and a housing 244. In addition, the coin-type secondary battery includes a ring-shaped insulator 220, a spacer 240, and a washer 242. As the electrode 204, an electrode formed by the above process in which an active material layer 202 is provided over a current collector 200 was used. The reference electrode 232 includes a reference electrode active material layer 230. In this example, the current collector was formed using a titanium foil, and the active material layer 202 was formed using the crystalline silicon layer described in Embodiment 1. The reference electrode active material layer 230 was formed using lithium metal (a lithium foil). The separator 210 was formed using polypropylene. The housing 206, the housing 244, the spacer 240, and the washer 242 which were used were made of stainless steel (SUS). The housing 206 and the housing 244 have a function of electrically connecting the electrode 204 and the reference electrode 232 to the outside.

The electrode 204, the reference electrode 232, and the separator 210 were soaked in the electrolyte. Then, as illustrated in FIG. 9, the housing 206, the electrode 204, the separator 210, the ring-shaped insulator 220, the reference electrode 232, the spacer 240, the washer 242, and the housing 244 were stacked in this order so that the housing 206 was positioned at the bottom of the stacked components. The housing 206 and the housing 244 were pressed and crimped to each other with a “coin cell crimper”. In such a manner, the coin-type secondary battery was formed.

The electrolyte in which LiPF₆ was dissolved in a mixed solvent of ethylene carbonate (EC) and diethyl carbonate (DEC) was used.

### (Process for Forming Comparative Secondary Battery)

A process for forming an electrode of the comparative secondary battery is described. A process for forming an active material layer of the comparative secondary battery is different from that of the secondary battery which is one embodiment of the present invention. The other structures of the comparative secondary battery are the same as those of the secondary battery which is one embodiment of the present invention; therefore, description of structures of a substrate, a current collector, and the like is omitted.

As the active material layer of the comparative secondary battery, crystalline silicon was used.

Amorphous silicon to which phosphorus was added was deposited by a plasma CVD method over a titanium film which was the current collector, and heating treatment was performed to form crystalline silicon. The deposition of the amorphous silicon by a plasma CVD method was performed as follows: silane and 5 vol % phosphine (diluted with hydrogen) were introduced as source gases into a reaction chamber with flow rates of 60 sccm and 20 sccm, respectively; the pressure of the reaction chamber was 133 Pa; the temperature of the substrate was 280° C.; the RF power source frequency was 60 MHz; the pulse frequency of the RF power source was 20 kHz; the duty ratio of the pulse was 70%; and the power of the RF power source was 100 W. The thickness of the amorphous silicon was 3 μm.

After that, heat treatment was performed at 700° C. The heat treatment was performed in an argon (Ar) atmosphere for six hours. By this heat treatment, the amorphous silicon was crystallized to form a crystalline silicon layer. The crystalline silicon layer thus obtained was used as the active material layer of the comparative secondary battery. Note that phosphorus (an impurity element imparting n-type conductivity) was added to this crystalline silicon layer.

### (Process for Forming Comparative Secondary Battery)

A process for forming the comparative secondary battery is described.

The active material layer was formed over the current collector in the above described manner and the electrode of the comparative secondary battery was formed. The comparative secondary battery was formed using the electrode. The comparative secondary battery was formed in a manner similar to that of the above secondary battery.

### (Characteristics of Secondary Battery and Comparative Secondary Battery)

The discharge capacity of the secondary battery and the comparative secondary battery were measured using a charge-discharge measuring instrument. For the measurements of charge and discharge, a constant current mode was used, charge and discharge were performed with a current of 2.0 mA and with the upper limit voltage of 1.0 V and the lower limit voltage of 0.03 V. All the measurements were performed at room temperature.

The initial characteristics of the secondary battery and the comparative secondary battery are shown in Table 1. Table 1 shows the initial characteristics of the discharge capacity per unit volume (mAh/cm³) of the active material layers. Here, the thickness of the active material layer of the secondary battery was 3.5 μm and that of the comparative secondary battery was 3.0 μm, and the discharge capacity (mAh/cm³) was calculated.

TABLE 1

| | Capacity (mAh/cm³) |
|---|---|
| Secondary battery | 7300 |
| Comparative secondary battery | 4050 |

As shown in Table 1, it was found that the discharge capacity of the secondary battery (7300 mAh/cm³) was approximately 1.8 times as high as the discharge capacity of the comparative secondary battery (4050 mAh/cm³).

In addition, the actual capacity of the secondary battery was close to the theoretical capacity (9800 mAh/cm³) of the secondary battery. In the above manner, by using the crystalline silicon layer formed by an LPCVD method as the active material layer, the secondary battery with an improved capacity that is close to the theoretical capacity was able to be formed.

This application is based on Japanese Patent Application serial no. 2010-125523 filed with Japan Patent Office on Jun. 1, 2010, the entire contents of which are hereby incorporated by reference.

1. An energy storage device comprising a crystalline silicon layer,
wherein the crystalline silicon layer comprises a plurality of protrusions on a surface of the crystalline silicon layer, and
wherein the plurality of protrusions comprise column-like protrusions and needle-like protrusions.

2. The energy storage device according to claim 1,
wherein the column-like protrusions comprise at least one of a cylinder-like protrusion and a rectangular column-like protrusion.

3. The energy storage device according to claim 1,
wherein the needle-like protrusions comprise at least one of a corn-like protrusion and a pyramid-like protrusion.

4. The energy storage device according to claim 1,
wherein the crystalline silicon layer serves as an active material layer.

5. An energy storage device comprising:
a current collector; and
a crystalline silicon layer over the current collector,
wherein the crystalline silicon layer comprises a crystalline silicon region and a whisker-like crystalline silicon region comprising a plurality of protrusions on the crystalline silicon region, and
wherein the plurality of protrusions comprise column-like protrusions and needle-like protrusions.

6. The energy storage device according to claim 5,
wherein the column-like protrusions comprise at least one of a cylinder-like protrusion and a rectangular column-like protrusion.

7. The energy storage device according to claim 5,
wherein the needle-like protrusions comprise at least one of a corn-like protrusion and a pyramid-like protrusion.

8. The energy storage device according to claim 5,
wherein the plurality of protrusions project upward from the crystalline silicon region.

9. The energy storage device according to claim 5,
wherein the energy storage device comprises a layer between the current collector and the crystalline silicon layer, and
wherein the layer comprises a metal element included in the current collector and silicon.

10. The energy storage device according to claim 5,
wherein the energy storage device comprises silicide between the current collector and the crystalline silicon layer, and
wherein the silicide comprises a metal element included in the current collector and silicon.

11. The energy storage device according to claim 5,
wherein the energy storage device comprises a layer between the current collector and the crystalline silicon layer,
wherein the layer comprises a metal element included in the current collector and silicon, and
wherein the metal element used in the current collector is zirconium, titanium, hafnium, vanadium, niobium, tantalum, chromium, molybdenum, tungsten, cobalt, or nickel.

12. The energy storage device according to claim 5,
wherein the energy storage device comprises silicide between the current collector and the crystalline silicon layer,
wherein the silicide comprises a metal element included in the current collector and silicon, and
wherein the metal element used in the current collector is zirconium, titanium, hafnium, vanadium, niobium, tantalum, chromium, molybdenum, tungsten, cobalt, or nickel.

13. The energy storage device according to claim 5,
wherein the crystalline silicon layer serves as an active material layer.

14. A method for manufacturing an energy storage device, comprising:
forming a crystalline silicon layer comprising column-like protrusions and needle-like protrusions over a current collector by a low-pressure chemical vapor deposition method using a deposition gas containing silicon.

15. The method for manufacturing an energy storage device according to claim 14,
wherein the column-like protrusions comprise at least one of a cylinder-like protrusion and a rectangular column-like protrusion.

16. The method for manufacturing an energy storage device according to claim 14,
wherein the needle-like protrusions comprise at least one of a corn-like protrusion and a pyramid-like protrusion.

17. The method for manufacturing an energy storage device according to claim 14,
wherein the crystalline silicon layer serves as an active material layer.
